(19) United States
(12) Patent Application Publication
(10) Pub. No.: US 2003/0112958 A1
(43) Pub. Date: Jun. 19, 2003

(54) Overlay view method and system for representing network topology

(76) Inventors: Luc Beaudoin, Gatineau (CA); Suzanne L. Rochford, Hull (CA); Doug D. Talbott, Kanata (CA); Arn C. Hyndman, Ottawa (CA); Thomas J. Stovicek, Kanata (CA)

Correspondence Address: Orange & Chari, Suite 4900, P.O. Box 190, 66 Wellington Street W., Toronto, M5K 1H6, CA

(21) Appl. No.: 10/025,925

(22) Filed: Dec. 26, 2001

Related U.S. Application Data
(60) Provisional application No. 60/339,343, filed on Dec. 13, 2001.

(51) Int. Cl. H04M 3/00

(52) U.S. Cl. 379/221.15; 379/247

(57) ABSTRACT

A method and system for a telecommunication network management tool to represent a telecommunication network layout including a plurality of distinct network entities related to one another by a variety of attributes. A user interface can be used for altering a display of a network representation model to help a system manager to systematically navigate the distinct network entities and associated attributes of the selected network. An overlay view selector is used for affecting the display content of the representation on the user interface. The view selector contains a plurality of presentation modes for altering the presentation of desired elements selected from the network layout. Presentation of the selected network includes an information subset displayed over a reference view, which helps the user to maintain the information subset in context of the network layout. The management tool can be used to select and highlight specific network entities in context to help increase network manager efficiency in network layout and maintenance.

The present invention relates to a method and system for representing and maintaining complex telecommunication network layouts, and in particular to the selected display of distinctive network subsets.

### BACKGROUND OF THE INVENTION

Global networks are common to all of today's telecommunication systems, wherein various data, optical, and wireless devices can be interconnected by a series of individual local networks. A global network generally consists of nodes and links, which describe the network topology, and associated attributes, which comprise the network data. The nodes and links may represent physical objects located in a geographical region, or non-physical objects such as software elements. The attributes can include basic measurements such as router intercommunication concerning a number of packets and web page access frequency, or computed aggregates such as average link utilization and number of address sites within a specified geographical region. The associated attributes may be static, such as link capacities, or time varying, such as network loading throughout a specified time period.

Today's telecommunication networks involve ever richer and more detailed information facets, which can require increasingly complex network management systems. These management systems now include such modelling concepts as management structures, routes and paths, and/or logical verses physical topologies. Furthermore, these systems must manage the transmission of data traffic, including voice, video, and data, and other information over a variety of transmission mediums, such as wireless, copper, and fibre optic lines. In addition, the management systems are also typically utilised in managing network growth and/or modification as the network evolves.

As telecommunication networks become increasingly complex, it becomes evermore important to monitor and maintain the various devices present on the network and their interconnections. These management systems depend on an adequate model representation of the connections between devices to support management tasks, such as configuration, route and path analysis, line or node failure detection, and other associated problem solving activities. A further issue in network management is network layout, which is an intensive and extensive process wherein each network item is carefully mapped, physically and logically, to facilitate differential and selectable item representations. Therefore, an important feature of network management systems is to assist network managers to differentiate the various connected devices and links, and to select them in a systematic fashion to effectively explore the model representation of the desired network. This differentiation can include the recognition of the element information subsets inside a combined network view, such as management structure, path, or route.

Accordingly, network interfaces that provide effective displays for representing network information are commonly used in network management systems, network provisioning systems, operation support systems, and numerous other applications. These displays can represent the network either logically or physically on a graphical user interface (GUI). The GUI can represent the network as a series of nodes connected by links, represented logically as a group of logical entities communicating through logical communication links, or as a group of physical devices located in physical locations connected by physical cables. A further GUI representation can be physical devices connected by logical communication links. Typically, the logical topology of a network does not correspond exactly to the physical topology. For example, a single physical device may constitute a plurality of logical entities or, similarly, a single physical cable may carry signals for a plurality of logical communication links. Accordingly, when exploring the representation of network configurations, it is desirable that the network manager can differentiate between the various links and attributes, and can select them in a systematic way to consider them in isolation or to compare them selectively.

Most network information in current management systems is permanently displayed inside the combined network view. The network view normally provides the total number of attached nodes and links as a combined view on the GUI. However, experience has shown that this single view is only practical in maintaining networks with a limited number of segments and associated nodes. Accordingly, as more connections are represented in the network along with their attributed information sets, this architecture can create a confusing structure of overlapping links and nodes crossing in all directions. This can cause problems in distinguishing between specific adjacent attached network elements, in identifying a desired node, and in selecting specific network items contained in the GUI display. Consequently, the topology and connection logic can get lost in a graphical chaos, which can increase the amount of time the network manager must spend in analysing the network. Furthermore, the nodes and associated links can be partially occluded or completely hidden from view, which can make the visual clutter more acute and tends to provide network representations that are visually cluttered, complex, and difficult to read and use.

One solution presently used in the art is that of multiple view network management software. This technique represents network configurations through multiple associated views, wherein the representation of desired sets/subsets of information are treated in a series of separate views. Each of the desired sets/subsets are displayed simultaneously in separate windows, where the content of a single window can be refreshed to represent the individual views. The network manager can then view descriptive information of each of the attached segments of the separate views in order to manage the network configuration. However, network managers must navigate these multiple views by browsing through them in sequence, wherein the success of this approach depends heavily upon the user's short-term visual memory. Accordingly, this technique quickly becomes tedious and error prone as the complexity of the initial view and of the related desired views increases, as well as when the number of windows exceeds a threshold for simultaneous display on a single display.

The above described multiple view management systems attempt to provide an improved method of viewing different desired sets of details, contained within the combined network view, that can be circumstantially useful when separated but confusing if displayed in a single combined network view. However, it has been found that the value of the subsets of information is often revealed when they are considered in relation to one another. Accordingly, in multiple view network management systems, this necessary contextual information can be lost or otherwise confused when the combined network view is split up into adjacent multiple subset views.

Another disadvantage of current telecommunication network management systems is that isolation of specific subsets contained in the combined Network view can be difficult, even more so when the reference network or the subset information is overly dense and complex, or when one is not familiar with these structures. Typically, network managers have to refer to some external list of elements composing the subset they seek and locate these in the combined network view. Each time an element is located, the network manager typically memorises the elements position to progressively compose a mental image of the subset in context with the combined network view, even when the identified elements are placed in separate multiple view representations.

A further disadvantage in current network management systems is the mapping of logical and physical topologies, since the actual network can support various combinations of multiple topology subsets. The correspondence between the physical and logical topology subsets can be very complex and difficult to represent inside the combined network view. For example, the termination of a logical link between two logical devices may indicate a hardware error in a physical device. However, before the error can be identified and repaired, the physical device corresponding to the logical device must be determined. Since this correspondence does not always exist in a one to one relationship between logical and physical devices, this determination may not be straightforward in its implementation. In addition, a logical map typically identifies logical entities by logical addresses or identification numbers, wherein these addresses generally do not convey information about the physical location of the physical device corresponding to the logical entity.

A further disadvantage with present network management systems is in the representation of multiple technologies, which is typically condensed inside a common visual language for representing the technology specific information in the combined Network view. Therefore, multiple technology views of combined Network views can preclude the simultaneous use of multiple specific technology visual representations for traffic status, such as the SONET protection and switching traffic display visual representation, for different network elements.

It is an object of the present invention to provide a system and method for representing telecommunication network layouts in order to obviate or mitigate some of the above-mentioned disadvantages.

### SUMMARY OF THE INVENTION

The present invention is directed to a method and system for a telecommunication network management tool to represent a combined telecommunication network layout, including a plurality of distinct network entities related to one another by a variety of attributes. A user interface is used for customizing a display of a base model representation, of the telecommunication network layout, through a selection of parameters to help a system manager systematically navigate the distinct network entities and associated attributes of the selected base model representation. An overlay view selector is used for affecting the display content of the representation on the user interface. The view selector contains a plurality of presentation modes for customizing the presentation of desired elements selected from the base model representation. Presentation of the selected network elements includes an information overlay subset displayed over a reference view, which helps the user to maintain the information overlay subset in context of the combined telecommunication network layout. The network management tool can be used to select and highlight specific network entities in context to help increase network manager efficiency in network layout and maintenance.

According to one aspect of the present invention there is provided a telecommunication network management tool for visually distinguishing a selected telecommunication information subset related to a selected telecommunication network layout. The tool comprises a user interface for assembling an altered representation of the network layout through a selected parameter. The user interface co-ordinates the display of the representation on a display. The tool also has a view selector coupled to the user interface for specifying the information set and a reference view, the reference view comprises a data subset contained in the network configuration. The tool also has a display controller coupled to the user interface for combining the information subset and the reference view to generate the representation according to the selected parameter, wherein the selected parameter affects the display content of the representation which provides a visual distinction between the selected information subset and the reference view of the representation.

According to a further aspect of the present invention there is provided a method for visually distinguishing a selected telecommunication information subset related to a selected telecommunication network layout. The method comprises the steps of: selecting a data set representing the selected network layout; specifying a selected parameter for providing the selected information subset and a reference view, the reference view comprises a data subset contained in the data set representing the selected network; combining the information subset and the reference view for assembling an altered representation according to the selected parameter; and displaying the altered representation on a display; wherein the selected parameter affects the display content of the altered representation which provides a visual distinction between the selected information subset and the reference view of the representation.

According to a still further aspect of the present invention there is provided a computer program product for visualizing a selected telecommunication information subset related to a selected telecommunication network layout. The product comprises: a computer readable medium; a user interface module stored on the medium for assembling an altered representation of the network layout through a selected parameter, the user interface module for co-ordinating the display of the representation on a display; a view selector module coupled to the user interface module for specifying the selected information subset and a reference view, the reference view comprises a data subset contained in the network layout; and a display controller module coupled to the user interface module for combining the selected information subset and the reference view to assemble the representation according to the selected parameter; wherein the selected parameter affects the display content of the representation which provides a visual distinction between the selected information subset and the reference view of the representation.

### BRIEF DESCRIPTION OF THE DRAWINGS

These and other features of the preferred embodiments of the invention will become more apparent in the following detailed description in which reference is made to the appended drawings wherein:

FIG. 1 shows a system for representing network layout;

FIG. 2 displays a combined network view of the system of FIG. 1;

FIG. 3 is a modified display of the combined network shown in FIG. 2;

FIG. 4a is a further embodiment of the system of FIG. 1;

FIG. 4b is a further embodiment of the system of FIG. 1;

FIG. 5 is a still further embodiment of the system of FIG. 1;

FIG. 6 a still further embodiment of the system of FIG. 1; and

FIG. 7 presents a flowchart for operation of the system of FIG. 1.

### DESCRIPTION OF THE PREFERRED EMBODIMENTS

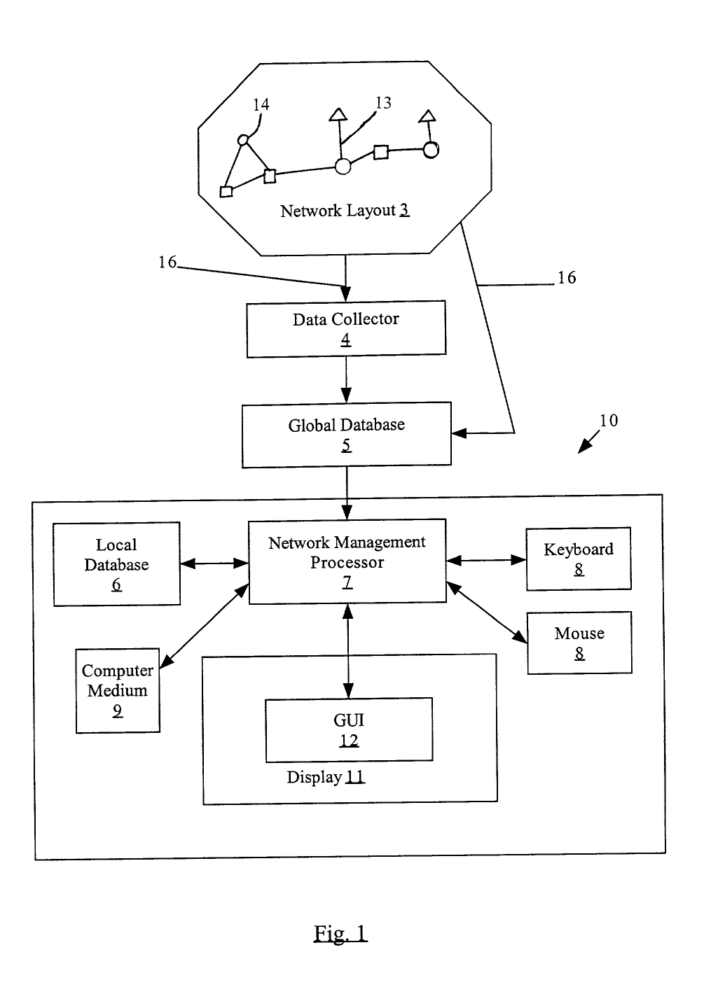

Referring to FIG. 1, a telecommunication network management tool 10 is coupled in series with a global database 5, a data collector 4, and one or more telecommunication network layouts 3, such as but not limited to a SONET network. The telecommunication network layout 3 is typically a set of interconnected communication devices or nodes 14 interconnected by links or segments 13, both physical and logical, which permit communication of data from one point in the telecommunication network layout 3 to another. Some examples of the telecommunication network layouts 3 are various technology types, including but not limited to; Synchronous Optical Networks (SONET), Synchronous Digital Hierarchy (SDH), Dense Wave Division Multiplexing (DWDM), Asynchronous Transfer Mode (ATM) Networks, and networks comprising a mixture of these technologies. The telecommunication network layout 3 can also include the Internet, networks of Microwave and Antenna Base Stations, and Satellite Networks. Regardless of the specific type, the telecommunication network layout 3 comprises a specified number of the communication devices 14 and the links 13, which each having a set of defined network features that can be collectively referred to as a telecommunication information set 16. For example, an ATM Network includes communication devices 14 and interconnections or links 13 that may be used for a particular customer and/or service. In other telecommunication network layouts 3, the communication devices 14 and links 13 may include such things as routers, antenna base stations, or interconnected segments that range from copper wire to fibre optic cable to microwave links.

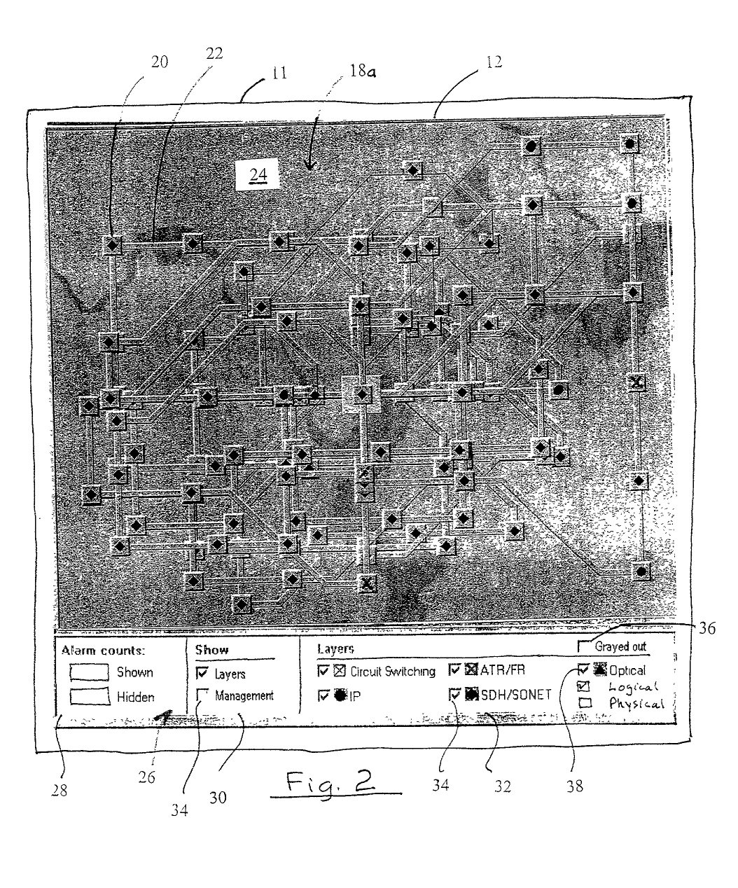

The network management tool 10 includes a display 11 for helping a network manager to monitor and maintain the communication devices 14 and links 13 of the telecommunication network layout 3. The display 11 includes a Graphical User Interface (GUI) 12 that provides the network manager with access to a run time object base model representation 18a of the telecommunication network layout 3 (see FIG. 2) on the display 11. The base model representation 18a represents a systematic display of the network layout 3. It should be noted that this systematic display typically contains a minimal number of devices 14 and links 13 and their respective attributes, also referred to as a standard reduced subset of the information set 16, so that the base model representation 18a is readable by the network manager. Therefore, the systematic display of the base model representation 18a typically cannot simultaneously represent all of the data contained in the information set 16, as desired for different aspects of network planning and maintenance, since the simultaneous detailed display of the information set 16 data usually results in a cluttered and unreadable presentation of the base model representation 118a on the display 11.

The network management tool 10 can be adapted to perform two functions for operating the display 11. Firstly, it can present the GUI 12 on the display 11 to enable the presentation of an altered version of the base model representation 18a with the communication devices 14, links 13, and attributes to the manager in a coherent manner, as well as to enable the receipt of instructions from the manager through a user input device 8 to provide for alteration instructions. Secondly, the network management tool 10 can co-ordinate the transfer of the information set 16 for storing in a local database 6 of the network management tool 10, and to perform processing on the information set 16 stored in the local database 6 in accordance with the instructions received from the manager through the user input devices 8 and a computer readable medium 9. This processing is used to put the information set 16 into the base model representation 18a in a desired format by the network manager for display on the display 11. The network management tool 10 thereby provides altered telecommunication overlay views 18b, c, d, e, f, (see additional figures) to help enable the efficient representation and exploration of the telecommunication network layout 3, through the use of selectively displayed and selected portions of the telecommunication information set 16.

The data collector 4 in communication with the network management tool 10 is preferably capable of collecting the information sets 16 concerning the communication devices 14 and links 13 contained within the telecommunication network layout 3. These information sets 16 can include, for example, logout data, element state, configuration data, connectivity data, categorisation data, and status and performance information. The possible status information set 16 can include a warning flag, a failure notice, another alarm indication, and an “OK” flag. The possible performance information set 16 can include signals comprising particular network entities error rates and percent utilization. The information sets 16 can be stored in the global database 5 as status and performance attributes respectively of the communication devices 14 and links 13, which is then accessed by the network management tool for storage in the local database 6.

The global database 5 receives and stores the information set 16 from the data collector 4. The entry of this information set 16 to the global database 5 could be made by a central operator at the global database 5, or alternatively could be communicated through the telecommunication network layout 3 and the data collector 4 by operators at remote locations, such as customer sites. Alternatively, this information set 16 may be entered into the global database 5 by having the communication devices 14 and links 13 contained in the telecommunication network layout 3 directly communicate with the global database 5. This information sets 16 can represent a substantially real time status of the communication devices 14 and links 13 contained within the telecommunication network layout 3, as available to the network management tool 10 to provide stable information sets 16 with minimized delay times. However, it should be noted that information sets 16 containing historical network status could also be stored if desired.

The computer system of network management tool 10 preferably comprises a network management processor 7 coupled to the global database 5. The network management processor is also coupled to the display 11 and to the user input devices 8, such as a keyboard, a mouse, or other suitable devices. If the display 11 is touch sensitive, then the display 11 itself can be the user input device 8. The computer readable medium 9 is coupled to the network management processor 7 for providing instructions to the network management processor 7 to perform steps or algorithms related to operation of the network management tool 10. The network management processor 7 can also act as a display controller for coordinating various combinations of the content included in the information set 16 for displaying the altered representation of the base model representation 18a (see FIG. 2) on the display 11. The computer readable medium 9 can include hardware and/or software such as, by way of example only, magnetic disks, magnetic tape, optically readable media such as CD ROMs, and semiconductor memory such as PCMCIA cards. In each case, the computer readable medium 9 may take the form of a portable item such as a small disk, floppy diskette, cassette, or it may take the form of a relatively largely or immobile item such as a hard disk drive, solid state memory card, or RAM provided in the computer system of the network management tool 10. It should be noted that the above listed examples of the computer readable medium 9 can be used either alone or in combination.

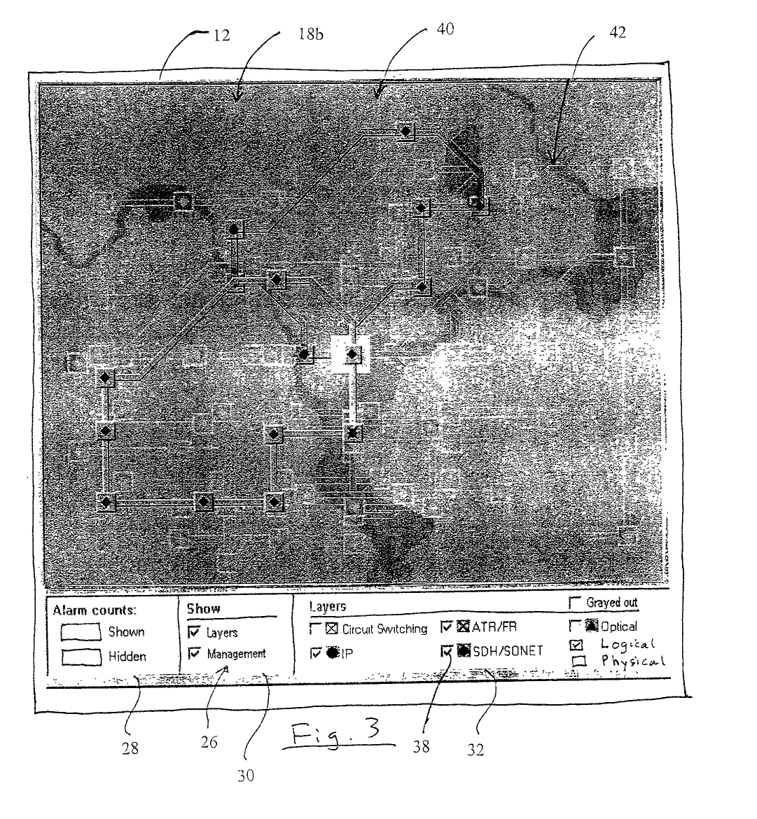

The local database 6 is coupled to the network management processor 7 to receive and store portions of the information set 16 corresponding to the communication devices 14 and links 13 within the telecommunication network layout 3 of interest, i.e. a user selected overlay information subset 40 (see FIG. 3) or snapshot of the information set 16 contained in the global database 5. The data of the information set 16 preferably consists of a direct containment hierarchy of the communication devices 14 and links 13, corresponding attributes for each of the network regions of interest, and an identification of where in each containment hierarchy each communication device 14 and link 13 is located. In some embodiments, the communication devices 14 and links 13 could be located in more than one location with the containment hierarchy, for example, if the communication devices 14 and links 13 are shared between two different customers.

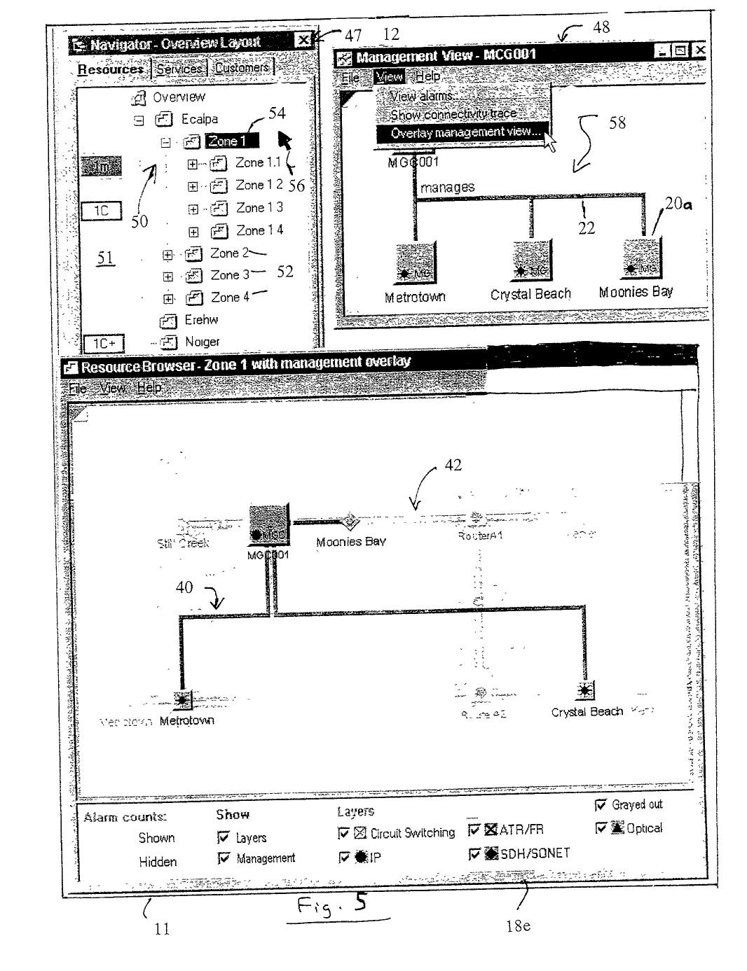

The information set 16 can be manually inputted to the local database 6 by operators using the user input devices 8, or can be downloaded in either “on” or “off” line modes from the global database 5. In the end, the local database 6 preferably maintains a network layout groups 50 structure (see FIG. 5) for each of the attribute layer containment hierarchies, with a particular network communication device 14 or link 13 being included in one or more groups. The network layout groups 50 define the base model representation 18a, which can be used to manage the telecommunication network layout 3 of interest. Alternatively, the local database 6 could maintain a list of the communication devices 14 and links 13 within the telecommunication network layout 3 of interest, along with a list of corresponding network features or attributes represented by the information set 16 that are associated with the communication devices 14 and links 13.

Referring to FIG. 2, the network management tool 10 includes the GUI 12 on the display 11, which contains the base model representation 18a. In the present example, the telecommunication network layout 3 is represented as a series of nodes 20 coupled by interconnection segments 22 for portraying the generic communication devices 14 and links 13. The base model representation 18a is presented on a background 24 of the GUI 12 and can be used to portray a visual representation of the selected actual telecommunication network layout 3, shown in FIG. 2 as the base model representation 18a. The GUI 12 also contains a control panel providing an overlay view selector 26 for allowing the network manager to control or otherwise alter the visual presentation of the base model representation 18a. These alterations can be used to add or delete the nodes 20 and segments 22 in a predetermined format as desired to generate altered overlay views 18b, c, d, e, and f, further described below.

The overlay view selector 26 has three sections 28, 30, 32 for providing various information to the manager about the visual content of the base model representation 18a. The section 28 includes the number of alarm counts that are contained in both the shown and hidden parts of the telecommunication network layout 3. Section 30 has two toggle boxes 34 for controlling the presentation of, such as but not limited to management views, connectivity traces, alarm conditions, traffic, performance, service alarms, and other desired attributes contained in the information set 16 of the selected corresponding nodes 20 and segments 22. Section 32 contains the toggle boxes 34 for various nodes 20 and segments 22 contained within the topology layers present in the base model representation 18a, such as but not limited to Circuit Switching, IP, ATR/FR, SDH/SONET, Optical, Logical, and Physical structures. Section 32 also contains a “grayed out” indicator 36, which by way of example only shows the manager that any toggle box 34 devoid of a check indicator 38 is either not present or shown in a ghosted view as further explained below.

Referring to FIG. 3, an altered overlay view 18b of the base model representation 18a is shown, which comprises a selected telecommunication information overlay subset 40 displayed over a telecommunication information subset or reference view 42. These subsets 40, 42 can be selected from the total information set 16 representing the telecommunication network layout 3. In the present example, the information overlay subset 40 represents an extracted or isolated Management view of the layers containing only IP, ATR/FR, SDH/SONET, and Logical components of the base model representation 18a. The components of Circuit Switching and Optical have been removed from the Management view, as noted by the lack of check indicators 38 in their respective toggle boxes 34 of section 32. Accordingly, the remainder of the base model representation 18a is shown as the reference view 42 in a grayed out or ghosted view format, thereby helping to relieve some of the visual clutter inherent in the base model representation 18a. Accordingly, the overlay view 18b can enable the manager to isolate the desired information overlay subset 40 from the base model representation 18a, but still maintain the presence of the reference view 42 to provide desired contextural secondary information. Accordingly, the detection and analysis of the information overlay subset 40 can become a pre-attentive visual cognitive process for the manager, while minimizing the visual load of the base model representation 18a.

One aid to minimizing the visual load of the base model representation 18a, while maintaining context, is the use of alternative visual characteristics for the reference view 42 that are distinct from the selected information overlay subset 40. Accordingly, the color, various lighter shadings, and transparent presentation formats of the selected information overlay subset 40 and remaining data subset of nodes 20 and segments 22 of the reference view 42 are used by the GUI 12 to help the network manager to identify or distinguish particular portions contained in, or in addition to, the base model representation 18a. A color coding scheme of the nodes 20 and segments 22 on the display 11 can be such as but not limited to; red, orange, and cyan yellow for various alarm states; green for IP segments 22 and nodes 20; mauve for optical or SONET segments 22 and nodes 20; yellowish green for switch nodes 20; and brown for wireless segments 22 and nodes 20. The target information overlay subset 40 is preferably represented as a saturated color, and the associated reference view 42 is preferably represented as a lighter shade or diluted version of the saturated color or in a substantially transparent or ghosted format. It is recognized that other color coding schemes and/or line types can be used to represent the various nodes 20 and segments 22 on the display 11.

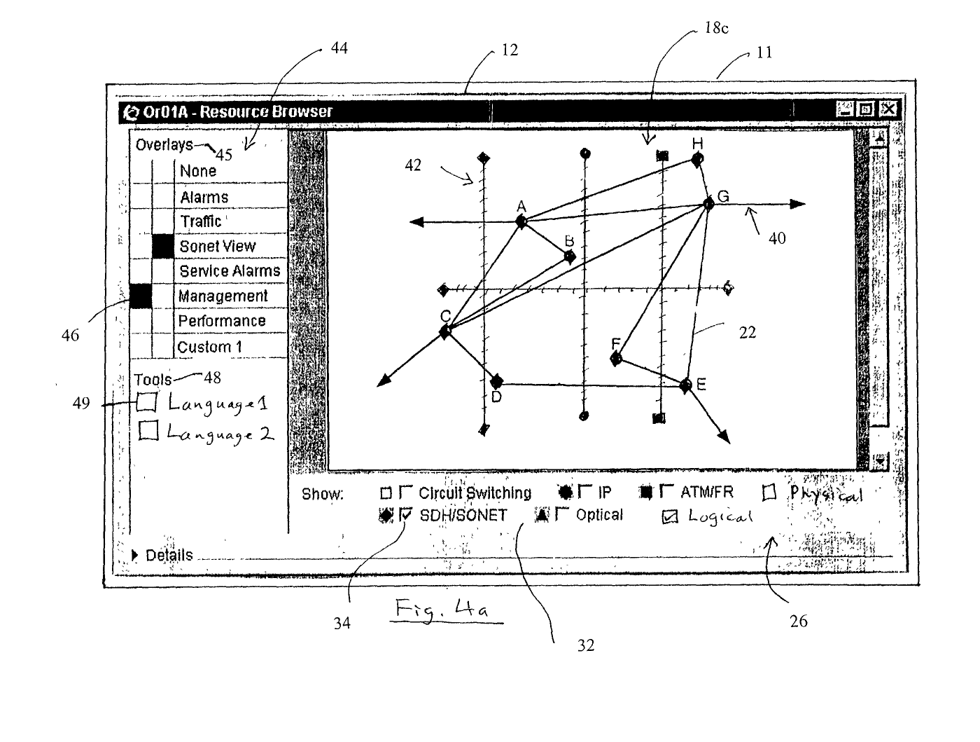

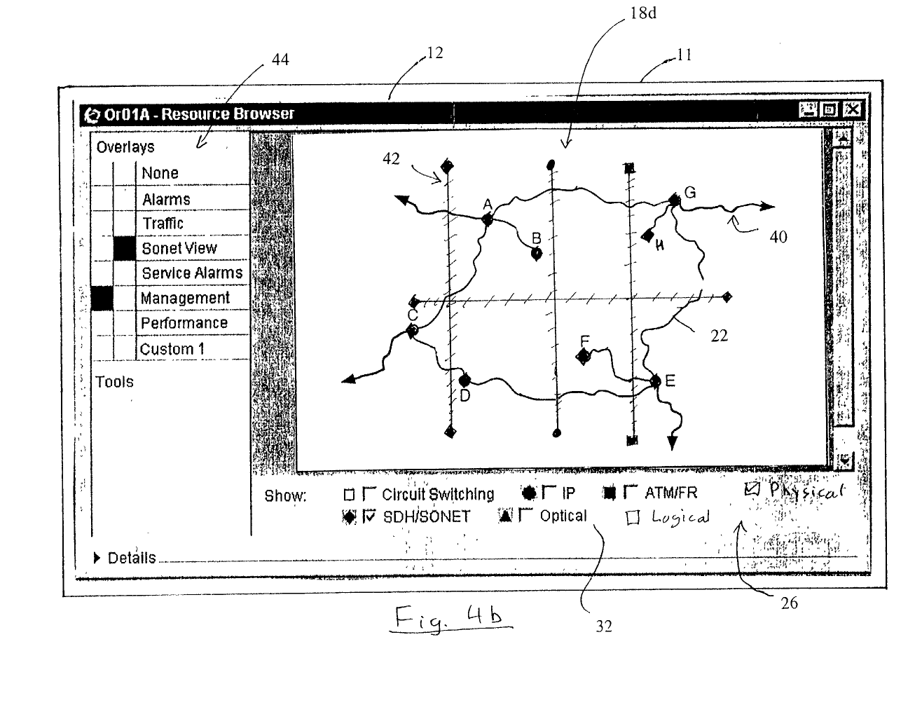

Referring to FIG. 4a, a further embodiment of the present invention shows an overlay view 18c containing the selected information overlay subset 40 in solid lines and the remaining reference view 42 in cross hatched lines. The display format of the overlay view 18c is a logical management view of SONET architecture showing only SDH/SONET nodes 20 and segments 22. It should be noted that the nodes 20 are presented by individual nodes A, B, C, D, E, F, G, and H. Accordingly, only the SDH/SONET and logical toggle boxes 34 are indicated in the section 32 of the overlay view selector 26. It should be noted that the non-selected nodes 20 and segments 22 listed in the section 32 are still shown in a less obvious or more subtle fashion for the reference view 42, for contextural purposes. However, the non-selected nodes 20 and segments 22 could also be excluded from view, or a subset thereof, from the overlay view 18c if desired to further minimize the visual clutter of the selected information overlay subset 40.

It should be noted that the GUI 12 could contain an additional overlay selector panel 44 detailing the type of overlay modes 45 selected for generation of the overlay view 18c. Block indicators 46 in the overlay selector panel 44 are used to indicate to the manager the overlay mode 45 selected. In addition to the overlay modes 45, the overlay selector panel 44 also contains a tool section 48 for providing selection and simultaneous display of the various available technology specific visual representations 49, such as but not limited to the SONET protection and switching language. These specific visual representations 49 can be used to overlay primary and/or secondary state information on the overlay view 18c, so as to provide more versatility in representing the information set 16 for visual indication of each network object such as nodes 20 and segments 22. It should be also noted that the overlay view 18c is displayed in a logical topology.

Referring to FIG. 4b, an augmented view 18d of the overlay view 18c is presented wherein the display type of the selected overlay subset 40 has been changed to a physical overlay topology, as indicated in section 32. It should be noted that in addition to the change in spatial location of physical device H in regard to the logical entity H, the segments 22 between the devices A, B, C, D, E, F, G, H have also changed in their corresponding dependencies. Furthermore, the reference view 42 remains displayed in the logical format, however a corresponding change to physical topology could also be selected if desired. Accordingly, the conversion from logical to physical topology of the selected information overlay subset 40 can be used to identify physical relationships and problems, which may be affecting the logical operation of the telecommunication network layout 3 represented by the information overlay subset 40. It should be recognized that various other combinations of overlay modes 45, technology specific visual representation 49, and selected devices and topologies in section 32 can be used by the manger to assemble the altered version, augmented view 18d, of the base model representation 118a. These other combinations can be used for the display 11 so as to contain the secondary contextural information represented by the reference view 42 in a less obvious or more subtle selected format in relation to the selected overlay subset 40, so as to assist in perceiving the most relevant way to reveal trends and co-relations inherent in the base model representation 18a. This visualization procedure of the network management tool 10 can thereby help to relieve some of the visual clutter inherent in the base model representation 18a, which otherwise may be difficult to detect and interpret by the network manager.

Referring to FIG. 5, another embodiment of the network management tool 10 includes a window on the GUI 12 referenced as an application launch menu 47. The launch menu 47 provides a way of launching the network management tool 10 from a regular network management application such as Nortel Networks Preside Application Platform. The launch menu 47 includes the network layout groups 50. The network layout groups 50 includes an associated series of individual network groups 52, contained within the telecommunication network layout 3, arranged in a hierarchical structure. These network groups 52 can also be organized in the launch menu 47 according to other user definitions or structures as desired. The network groups 52 can be defined according to a number of attributes including; network region, technologies, operator, customers, and combinations thereof. The launch menu 47 can also contain alarm banners 51, which display an alarm count for each of the associated network groups 52. The alarm count includes alarms for sub-groups of the network groups 52, when these sub-groups are not displayed in the launch menu 47 because the sub-groups are located in closed sections of the network layout groups 50 hierarchy displayed in the launch menu 47.

Upon selection of one of the network groups 52, indicated for example as a highlighted row 54 adjacent to a cursor 56, the selected groups 52 can be displayed as the target information subset 40 in a resource browser window (not shown) on the GUI 12. The network manager can then select the node 20 of interest, indicated as MGG001, from the resource browser window for corresponding display in a management view window 48. The management view window 48 provides for an isolated display of a management organization structure 58 controlling the selected node 20 of interest (MGG001). Accordingly, using this management view window 48 shows the selected node MGG001 managing the associated nodes 20a, referred to as Metro Town, Crystal Beach, and Moonies Bay. These additional associated nodes 20a may not be contained within the selected network group 52, rather they can be contained by other network groups 52 of the network management structure 50, and/or in the global database 5 and obtained by the network management tool 10 for supplementing the relational display shown the management view window 48 for the selected node MGG001. The network manager could also manually select other nodes 20 shown in the resource browser window (not shown), as contained in the selected group 52 and represented by the target information subset 40, for display in the management view window 48. It is recognized that alternatively, nodes 20 managing the selected node MGG001 could also be displayed in the network management window 48, if desired. It should be noted that the management organization structure 58 can be independent of the structure of the network layout groups 50, such that there can be multiple network layout groups 50 for the management organization structure 58.

An alternative approach to display the management information, associated with the node 20 of interest, is to assemble the overlay view 18e where the target information overlay subset 40 containing the information management information would be displayed in context with the reference view 42. However, it should be noted that additional nodes 20a not contained within the reference view 42 would not be displayed using this approach.

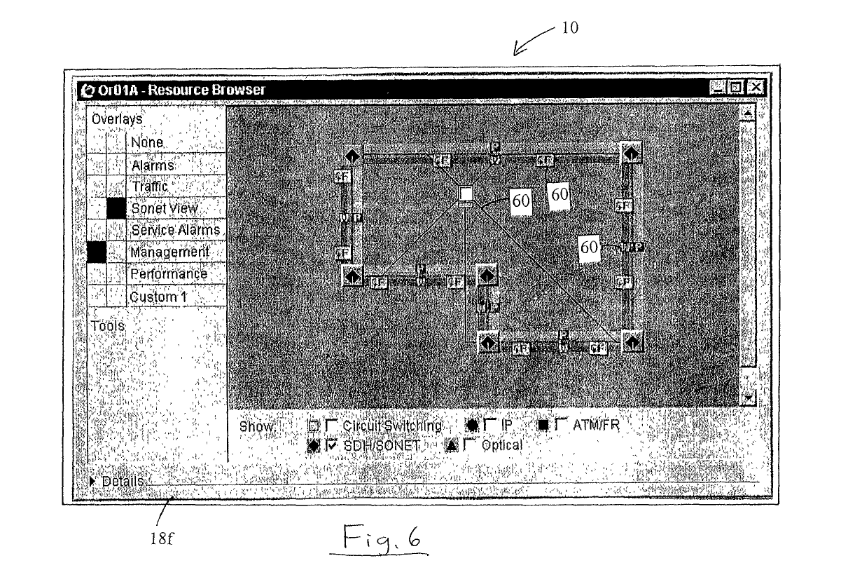

Referring to FIGS. 5 and 6, a further embodiment of the network management tool 10 shows an augmented overlay view 18f with a set of specialized details 60 included in the selected information overlay subset 40, which are circumstantially useful, but would significantly reduce the overall usability of the base model representation 18a if they were displayed permanently. These specialized details 60 can include pre-defined telecommunication information sets 16 having detailed technology specific visual representations 49 for primary state and secondary state information contained within the information set 16, which can be displayed over the reference view 42 upon selection in the overlay selector panel 44. The use of multiple specific visual representations 49 to generate the altered overlay views 18b, c, d, e, f can help the manager to consider the specialized details 60 in reference to a stable topology of nodes 20 and segments 22, and can avoid permanently cluttering the base model representation 18a with circumstantially useful information. Accordingly, the use of selected information overlay subsets 40 with specialized details 60, to provide the application of multiple technology specific visual representations 49 in parallel, can help the development of more versatile management systems. Other specialized details 60 can also include but are not limited secondary management, historical performance and/or traffic data.

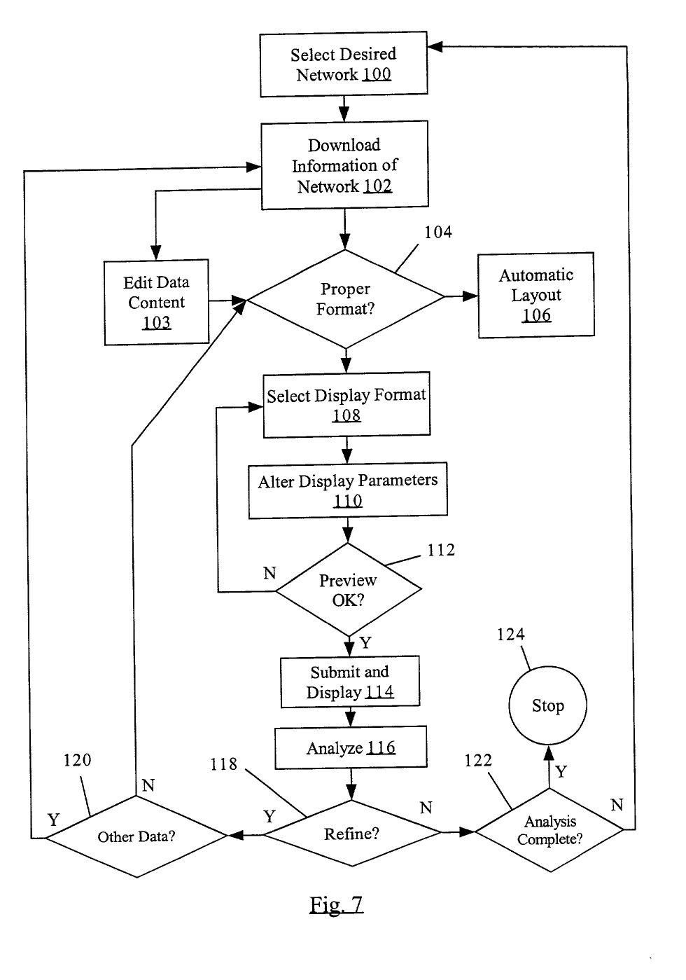

Referring to FIG. 7 for operation of the network management tool 10, the manager can select 100 the desired network groups 52 from the telecommunication network layout 3 to be displayed on the GUI 12. Accordingly, the corresponding information set 16 is either downloaded from the databases 5, 6 or retrieved by the data collector 4 and sent to the network management processor 7 at step 102. The manager then decides 104 whether the selected network groups 52 and corresponding content of information set 16 is in a suitable format for display of the base model representation 18a on the GUI 12, which can include predefined information overlay subsets 40 and corresponding reference views 42. These predefined information subsets 40, 42 could have been generated in a save mode in previous applications of the GUI 12 to represent the base model representation 18a. In addition, editing of the data content of the information set 16 at step 103 can be done by using the network management tool as an editing facility to layout the desired communication devices 14 and links 13. As the communication devices 14 and links 13 are constructed, they are assembled into the common GUI 12 display. The manager can use the network management tool 10 to construct the number and position of the nodes 20, the length and orientation of the segments 22, and assemble the corresponding attribute information set 16 related thereto. The manager can also choose the format of the background 24 to represent such as but not limited to specific topologies, geography, pre-defined or custom patterns, an abstract representation, or a saturated color. It is also recognized that traditional editing facilities could be used to edit the telecommunication network layout 3 prior to analyzing the edited versions by the network management tool 10.

In the event the display format of the base model representation 18a is suitable, or a suitable pre-defined or saved custom format is available, the network management tool 10 then proceeds to automatically 106 display the selected information overlay subset 40 and corresponding reference view 42, if applicable, by using the network management processor 7 as the display controller. However, if the display format is not suitable 108 upon selection of the network groups 52, then the manager can use the overlay view selector 26 and selected parameters, and corresponding additional overlay selector panel 44 if appropriate, for altering 110 the base model representation 18a to highlight the selected information subset 40 in context with the reference view 42 obtained from the information set 16. This alteration procedure can use the attributes of the network management window 48 and preview function 112 of the launch menu 47, if desired. The altered overlay view 118b, c, d, e, f can include any desired selection of parameters for specific device layers, logical verses physical modes, color and/or ghost view distinction of the reference view 42 with respect to the selected information overlay subset 40, technology specific visual representations 49, and indication of management views and alarm status. The alteration can also include augmentation and/or overlay modes 45 of the selected information overlay subset 40 with respect to the reference view 42, as well as the addition of the specilized details 60.

Once the selected information overlay and reference data subsets 40, 42 are displayed 114 as the altered overlay view 18b, c, d, e, f, the network manager can analyse 116 the displayed overlay view 18b, c, d, e, f and update the time varying contents as desired. The display of the selected information overlay subsets 40 in the overlay views 18b, c, d, e, f, with the reference view 42, can be toggled on and off on demand of the manager, thereby allowing application of the overlay subsets 40 only when deemed relevant to the analysis at hand. In the event that further refinements 118 to the display format of the overlay view 18b, c, d, e, f are desired, the manager can either request 120 added or deleted data from the information set 16, and/or proceed to repeat the alteration procedure at step 104. Once the analysis is complete 122, the management task of the network management tool 10 is completed at step 124.

In the event that the manager can determine all requirements from the presently displayed altered overlay view 18b, c, d, e, f, the manager can then stop 124 the analysis or can select an alternative base model representation 18a at step 100. Accordingly, operation of the network management tool 10 can help the manager to provide the selected information overlay subsets 40 that can be removed when not needed to reduce visual noise, thus minimizing visual load. Furthermore, the network management tool 10 also facilitates the isolation of selected information overlay subsets 40 in the modified overlay view 18b, c, d, e, f to help reduce the perceived complexity of the base model representation 18a, and the cognitive efforts required to perform this distinction of the selected information overlay subset 40. When displayed to enrich or otherwise augment the reference view 42, the selected information overlay subset 40 can be displayed showing only the minimum amount of extra visual elements desired at any one time. This system thus helps to restrict the density and complexity of the base model representation 18a, as desired. Furthermore, the extra specialized details 60 can also be displayed in contrast with the reference view 42 to reduce the required complexity of the base model representation 18a. These specialized details 60 can also help to reduce the cognitive efforts required to distinguish the selected information overlay subset 40, representing the specialized details 60, from the remaining elements of the base model representation 18a, represented by reference view 42.

It is recognized that the manager can construct simultaneous and alternate overlay views 18b, c, d, e, f of the base model representation 18a on the GUI 12, for use in the detection and maintenance of elaborate network inter relationships, while maintaining contextural information therein. Accordingly, the selection of various information overlay subsets 40 and corresponding reference views 42 using the overlay view selector 26 can be implemented in various fashions depending upon the number of selected information overlay subsets 40 and the possible combination of these within, and external to, the base model representation 18a. Accordingly, this implementation can help provide the ability to visually isolate the selected information overlay subsets 40 in context from the combined information set 16 contained in the base model representation 18a.

These selected information overlay subsets 40 can be generated from data typically internal or systematic to the standard reduced subset of the information set 16, which provides for a systematically displayed base model representation 118a. The overlay subsets 40 can be assembled from this standard reduced subset through the selection of various selected parameters, such as but not limited to the contents of section 30 for management views, connectivity traces, alarm conditions, traffic, performance, service alarms, and in section 32 for topology layers including circuit switching, IP, ATR/FR/SDH/SONET, optical, logical and physical modes. Accordingly, the total information set 16 typically contains more network information than can be represented by displaying the base model representation 18a, otherwise an over-cluttered and unworkable display could result. Therefore, the base model representation 18a is typically displayed initially using the standard reduced subset of the information set 16, before altered by the network manager through removal of material from the standard reduced subset or addition of material represented by the specialized details 60.

The selected parameters can also include indicators 36 for providing alternate presentation schemes including grayed out or ghosted view formats, alternate colours, various shadings, and transparent presentation formats. The selected parameters can also include overlay modes 45, technology specific visual representations 49, as well as network regions 50, network configurations 52, and various display options 48 such as view alarms, connectivity trace display, and overlay management views. Alternatively, the information overlay subsets 40 can be augmented by including some specialized details 60 contained within the information set 16, but otherwise unusable for generating the display of the base model representation 18a. These specialized details 60 are typically external to the standard reduced subset of the information set 16 used to systematically generate the base model representation 18a. Accordingly, these specialized details 60 can be requested by the network manager for inclusion in the overlay subset 40. It should be noted that the specialized details 60 preferably remain external to the standard reduced subset of the information set 16, and therefore only implemented upon request by the network manager to help minimize visual clutter of the overlay views 18b, c, d, e, f. The selected parameters can also include sets of specialized details 60 including secondary management, historical performance, and/or traffic data.

It is further recognized that operation of the network management tool 10 can be provided by computer network representation software contained in the above described network management tool 10, as software and/or hardware modules represented by the computer readable media 9. It is further recognized that communication devices 14 and links 13, nodes 20, and segments 22 can also be referred to collectively as network entities or elements.

Although the invention has been described with reference to certain specific embodiments, various modifications thereof will be apparent to those skilled in the art without departing from the spirit and scope of the invention as outlined in the claims appended hereto.

The embodiments of the invention in which an exclusive property or privilege is claimed are defined as follows:

1. A telecommunication network management tool for visually distinguishing a selected telecommunication information subset related to a selected telecommunication network layout, the tool comprising:
a) a user interface for assembling an altered representation of the network layout through a selected parameter, the user interface coordinating the display of the representation on a display;
b) a view selector coupled to the user interface for specifying the selected information subset and a reference view, the reference view comprising a data subset contained in the network layout; and
c) a display controller coupled to the user interface for combining the information subset and the reference view to generate the representation according to the selected parameter;
wherein the selected parameter affects the display content of the representation which provides a visual distinction between the selected information subset and the reference view of the representation.

2. The tool according to claim 1, wherein the information subset is selected from the group comprising: a first data subset contained in an information set for systematic presentation of the network layout; and a second data subset external to the information set for augmenting the systematic presentation of the network layout.

3. The tool according to claim 2, wherein said view selector further comprises a plurality of the selected parameters for contributing to the contents of said information subset.

4. The tool according to claim 3, wherein the selected parameter is selected from the group comprising technology types, logical modes, and physical modes.

5. The tool according to claim 3, wherein the contents of said information subset is distinguished from said reference view through a selected visual characteristic.

6. The tool according to claim 5, where said visual characteristic is selected from the group comprising; colour, shading, degree of transparency, and line type.

7. The tool according to claim 3, wherein the selected parameter is a technology specific visual representation different from the representation employed to display said reference view.

8. The tool according to claim 7, wherein said technology specific visual representation facilitates the display of primary state information.

9. The tool according to claim 7, wherein said technology specific visual representation facilitates the display of secondary state information.

10. The tool according to claim 7, wherein the selected parameter is a technology specific visual representation different from the representation employed to display said reference view.

11. The tool according to claim 3 further comprising a save mode for storing the selected parameters for application to alternative ones of said information set.

12. The tool according to claim 2 further comprising a toggle switch for adding or removing a selected one of said information subsets from the display of said representation on demand.

13. The tool according to claim 3, wherein a plurality of the information subsets are combined with said reference view for display as the representation.

14. The tool according to claim 12, wherein a plurality of the information subsets are combined with said reference view for display as the representation.

15. The tool according to claim 2, wherein said view selector further comprises a plurality of the selected parameters for contributing to the contents of said information subset.

16. The tool according to claim 15, wherein the selected parameter is selected from the group comprising technology types, logical modes, and physical modes.

17. The tool according to claim 15, wherein the contents of said information subset is distinguished from said reference view through a selected visual characteristic.

18. The tool according to claim 17, where said visual characteristic is selected from the group comprising; colour, shading, degree of transparency, and line type.

19. A method for visually distinguishing a selected telecommunication information subset related to a selected telecommunication network layout, the method comprising the steps of:
a) selecting a data set representing the selected network;
b) specifying a selected parameter for providing the selected information subset and a reference view, the reference view comprising a data subset contained in the data set representing the selected network;
c) combining the information subset and the reference view for assembling an altered representation according to the selected parameter; and
d) displaying the altered representation on a display;
wherein the selected parameter affects the display content of the altered representation which provides a visual distinction between the selected information subset and the reference view of the representation.

20. A computer program product for visualizing a selected telecommunication information subset related to a selected telecommunication network layout, the product comprising:
a) a computer readable medium;
b) a user interface module stored on the medium for assembling an altered representation of the network configuration through a selected parameter, the user interface module for coordinating the display of the representation on a display;
c) a view selector module coupled to said user interface module for specifying the selected information subset and a reference view, the reference view comprising a data subset contained in the network layout; and
d) a display controller module coupled to said user interface module for combining the information subset and the reference view to assemble the representation according to the selected parameter;
wherein the selected parameter affects the display content of the representation which provides a visual distinction between the selected information subset and the reference view of the representation.
